(19) United States
(12) Patent Application Publication
(10) Pub. No.: US 2001/0007097 A1
(43) Pub. Date: Jul. 5, 2001

(54) System and method for recording internet advertisement access history

(76) Inventor: Yong-Nam Kim, Seongnam-city (KR)

Correspondence Address: Y. Rocky Tsao, Fish & Richardson P.C., 225 Franklin Street, Boston, MA, 02110-2804, US

(21) Appl. No.: 09/749,311

(22) Filed: Dec. 27, 2000

(30) Foreign Application Priority Data
Jan. 4, 2000 (KR) 2000-194
Dec. 8, 2000 (KR) 2000-74692

(51) Int. Cl. G06F 17/60

(52) U.S. Cl. 705/14

(57) ABSTRACT

Disclosed is an advertisement access history recording system which comprises a user authentication server for determining whether the user who accesses an advertisement providing web site logs in to the advertisement providing web site, and storing the user's personal information; a web server for managing the advertisement providing web site for storing a selection of the advertisement, execution of the selected advertisement, computation of run time of the selected advertisement and run time of the computed advertisement run time in the user authentication server; and an advertisement data server for storing the advertisements provided by the advertisement providing web site. According to the present invention, the sponsor can accurately know data such as the number of the users and advertisement run time.

### BACKGROUND OF THE INVENTION

(a) Field of the Invention

The present invention relates to Internet advertisement. More specifically, the present invention relates to a system and method for recording an Internet user's accessing history to Internet advertisements.

(b) Description of the Related Art

The Internet originated from the ARPANET for sharing information on military research by the U.S. Pentagon, and it has now become an effective information accumulating and providing medium to which a plurality of computer networks is connected all over the world. The Internet has been applied to electronic mail, news groups, file transfer, information transmission and search etc., and as the number of networks connected to the Internet and Internet users has greatly increased, the Internet has come to be used as an advertisement tool, and corresponding markets have greatly increased.

Because of the great increase in the Internet advertisement demand, sponsors have come to need correct data on how many Internet users watch the Internet advertisements.

However, conventional methods for recording information on Internet advertisement access only allow the sponsors to know the number of users who access the corresponding web pages and the time frames during which the users stay on the web pages. Because of the above-noted problem, the sponsors cannot exactly know the cases wherein a single user repeatedly clicks the sponsor's advertisement or the user accesses the web page but does not watch the advertisement, and hence it is difficult to compute correct advertisement cost.

### SUMMARY OF THE INVENTION

It is an object of the present invention to provide a system and method for recording Internet advertisement access history to obtain accurate advertisement access information by receiving time during which the advertisement data is actually executed, and personal information on the user who executes the advertisement data.

In one aspect of the present invention, in an advertisement access history recording system for obtaining both a number of users who receive the advertisements and advertisement run time, an advertisement access history recording system comprises a user authentication server for determining whether a service user who accesses an advertisement providing web site logs in to the advertisement providing web site, and storing the user's personal information; a web server for managing the advertisement providing web site for storing a selection of the advertisement, execution of the selected advertisement, computation of run time of the selected advertisement and run time of the computed advertisement run time in the user authentication server; and an advertisement data server for storing the advertisements provided by the advertisement providing web site.

The advertisement providing web site comprises: an advertisement selection unit stored in the advertisement data server and having indices linked to the advertisements including execution time per frame and the advertisement data; and an advertisement execution unit for reproducing the advertisement data when the user executes the selected advertisement and computing the advertisement data reproduction time using the execution time per frame.

The advertisement providing web site further comprises a survey unit for examining the way of thinking of the service user who executes the advertisement.

The advertisement providing web site further comprises a use accumulation unit for showing the service user's accumulated incentives provided by the web server.

In another aspect of the present invention, in an advertisement access history recording method for obtaining a number of users who receive the advertisements and advertisement run time, an advertisement access history recording method comprises the steps of: a web server transmitting an advertisement providing web site to a service user; the web server selecting the advertisements and providing the same to the service user; the web server receiving the advertisement selected by the service user from the service user; the web server determining whether the advertisement selected by the service user exceeds a use limit; the web server executing the advertisement when it is determined that the advertisement selected by the service user does not exceed the use limit; and the web server providing points to the service user who watches the advertisement.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a system for recording an Internet advertisement accessing history according to a preferred embodiment of the present invention;

FIG. 2 shows a block diagram of an advertisement providing web site according to the preferred embodiment of the present invention;

FIG. 3 shows a flow chart of a method for recording an Internet advertisement accessing history according to the preferred embodiment of the present invention;

FIG. 4 shows a flow chart for a user to be authenticated according to the preferred embodiment of the present invention;

FIG. 5 shows a flow chart of a method for recording an Internet advertisement accessing history according to the preferred embodiment of the present invention; and

FIG. 6 shows a method for using points according to the preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

FIG. 1 shows a block diagram of a system for recording an Internet advertisement accessing history according to a preferred embodiment of the present invention.

As shown, the system for recording an Internet advertisement accessing history comprises a web server 120 comprising an advertisement providing web site 125, a user authentication server 130 and an advertisement data server 140 in an Internet advertisement access history recording system comprising a terminal 100 comprising a web browser 105 and an Internet service provider (ISP) 110 for connecting the terminal 100 to the Internet network.

The terminal 100 enables bidirectional communications. For example, the terminal 100 can be a computer connected to a communication network, mobile communication terminals such as PCS and IMT2000 or digital television enabling bi-directional information communication.

The web server 120 comprises an advertisement providing web site 125 for executing advertisements after setting advertisement execution options and recording the advertisement execution time, and when an Internet user connects his terminal 100 to the Internet via the ISP 110 and transmits a uniform resource locator (URL) signal of the advertisement providing web site via the web browser of his terminal to the web server 120, the web server 120 accesses an advertisement providing web site 125 corresponding to the URL signal to the Internet user's terminal 100.

When the Internet user accesses the advertisement providing web site 125, inputs ID and password and logs in to the web site 125 in order to receive advertisements, the user authentication server 130 determines a log in state of the Internet user and stores advertisement conditions including the Internet user's age, sex and place of residence.

The advertisement data server 140 stores advertisement data provided to an index of an advertisement selection unit 126.

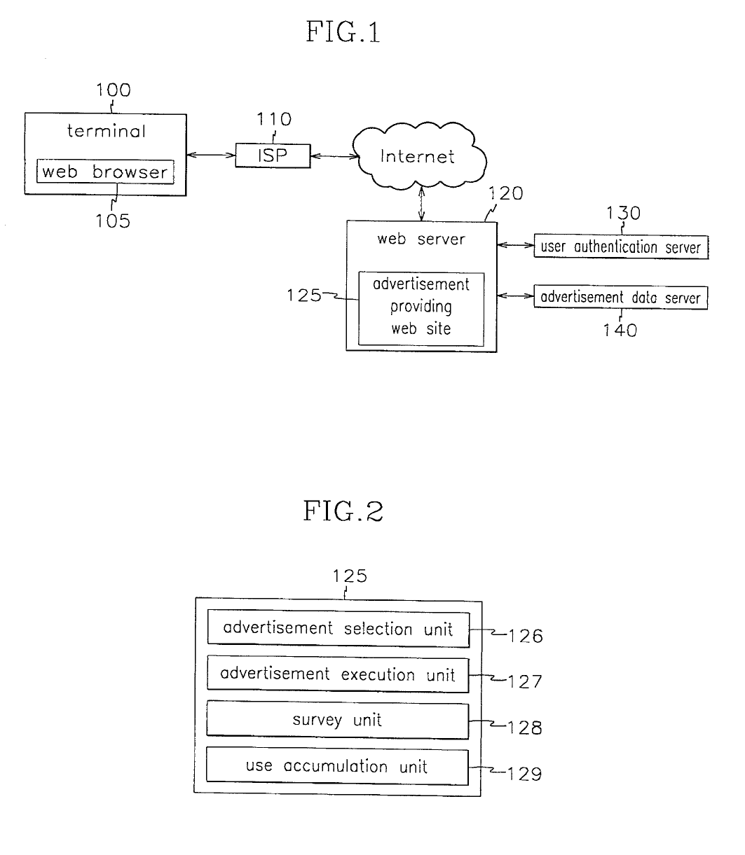

FIG. 2 shows a block diagram of the advertisement providing web site 125 according to the preferred embodiment of the present invention.

As shown, the advertisement providing web site 125 comprises an advertisement selection unit 126, an advertisement execution unit 127, a survey unit 128 and a use accumulation unit 129.

The advertisement selection unit 126 comprises indices of the advertisements to be provided to Internet users who log in to the advertisement providing web site 125. At this time, the advertisements linked to the respective indices comprise the advertisement conditions such as sex, age and location, running time per frame and advertisement data. Hence, the web server 120 checks the advertisement conditions of the advertisement selected by the Internet user and those of the Internet user stored in the user authentication server 130, and determines whether to provide an advertisement. Also, the web server 120 receives information on an advertisement use limit from the user authentication server 130 and prevents a single Internet user from repeatedly receiving the advertisement so as to obtain correct information on the Internet users who receive the advertisements, provide the advertisements only to those who satisfy the advertisement conditions and get actual advertisement impacts. For example, in the case of advertising products for housewives in their thirties, the advertisement conditions are restricted to ladies in their thirties, and accordingly it can be found how many of the consumers actually have received the advertisements.

When the Internet user who satisfies the advertisement conditions executes an advertisement, the advertisement execution unit 127 displays the advertisement data. That is, the advertisement execution unit 127 reads the running time per frame and the advertisement data included in the advertisement, accumulates the running time during which the advertisement data are displayed, and computes the data displaying time. According to the above-noted operation, the time frame during which the Internet user actually watches the advertisement can be detected, and the web server 120 stores information on the time frame in the user authentication server 130.

The survey unit 128 performs surveys on the Internet users' way of thinking, such as impressions of the displayed advertisements, whether they have used the advertised products, as well as an amount of time they use the Internet per day. When the Internet user answers the survey, the web server 120 can provide incentive points to the Internet user.

The use accumulation unit 129 displays the accumulated incentives of the Internet user who watches the advertisement, and the accumulated incentives are stored in the user authentication server 130 by the web server 120. Values of the respective incentives assigned to the advertisements in the indices of the advertisement selection unit 126 can be different.

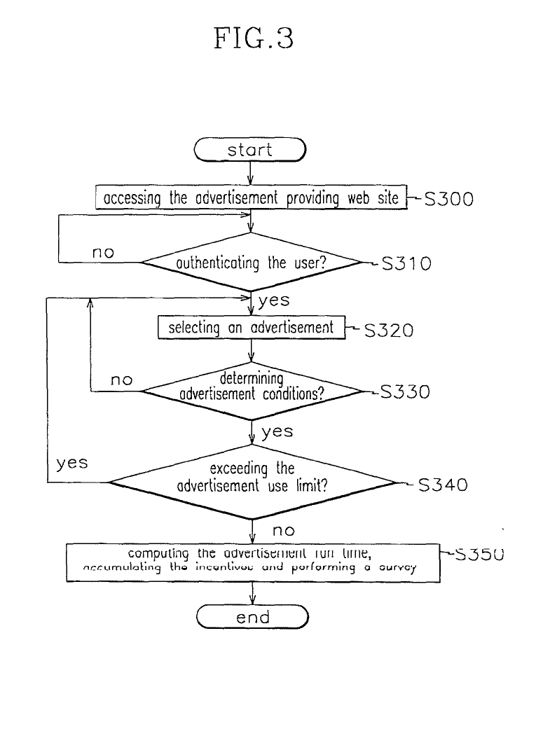

FIG. 3 shows a brief flow chart of a method for recording an Internet advertisement accessing history according to the preferred embodiment of the present invention.

As shown, the method for recording an Internet advertisement accessing history comprises the steps of accessing an advertisement providing web site in step S300, authenticating a user in step S310, selecting an advertisement in step S320, determining advertisement conditions in step S330, determining if an advertisement use limit has been exceeded in step S340 and computing an advertisement execution time frame, accumulating the incentives and performing a survey in step S350.

When an Internet user accesses the Internet via the ISP 110 with his terminal 100 and transmits a URL signal of the advertisement providing web site 125 to the web server via the web browser 105 of the terminal 100, the web server transmits the advertisement providing web site 125 of a corresponding URL to the Internet user's terminal in step S300.

When receiving the advertisement providing web site 125 at his terminal 100, the Internet user inputs his ID and password so as to log in to the advertisement providing web site 125, and then the user authentication server 130 checks the ID and password provided by the Internet user and determines the Internet user's login state in step S310.

After logging in to the advertisement providing web site 125, the Internet user selects desired advertisements from the advertisement selection unit 126 of the advertisement providing web site 125 in step S320. The web server 120 receives the advertisement conditions and the Internet user's conditions from the advertisement data server 140 and the user authentication server 130, compares the above-noted conditions, and when they are found to be identical, it goes to a step of determining an advertisement use limit in step S330. That is, the advertisements in the indices of the advertisement selection unit 126 include the conditions of the Internet users who can receive the advertisements and limit the Internet users. Because of the above-noted limitations for limiting the users to be advertised to according to the advertisement conditions, the sponsors can not only reduce the advertisement cost but also obtain accurate data on the advertised Internet users.

Also, the web server 120 receives the number of the Internet user's receipts of the advertisements from the user authentication server 130 and determines an excess state of the advertisement use limitation of the Internet user in step S340. Through the above-noted procedure, the Internet user is prevented from repeatedly selecting the advertisement on purpose, and hence the sponsor can accurately know the number of the persons who receive the advertisements.

When the use limitation is not exceeded, the advertisement execution unit 127 executes the advertisement selected by the Internet user. At this time, the advertisement execution unit 127 executes the advertisement, accumulates information on time per frame provided to the advertisement, and computes the advertisement execution time. Also, as the advertisement execution unit 127 executes the advertisement, the web server 120 computes the incentives provided to the advertisement selection unit 126, stores the same in the user authentication server 130 and displays the Internet user's incentives accumulated thus far via the use accumulation unit 129. When the advertisement execution unit 127 finishes the advertisement execution, the web server 120 directs the survey unit 128 to ask a lot of questions about the advertisements to the Internet user.

According to the above-noted procedure, the sponsor can actually glean a lot of data on the advertisements.

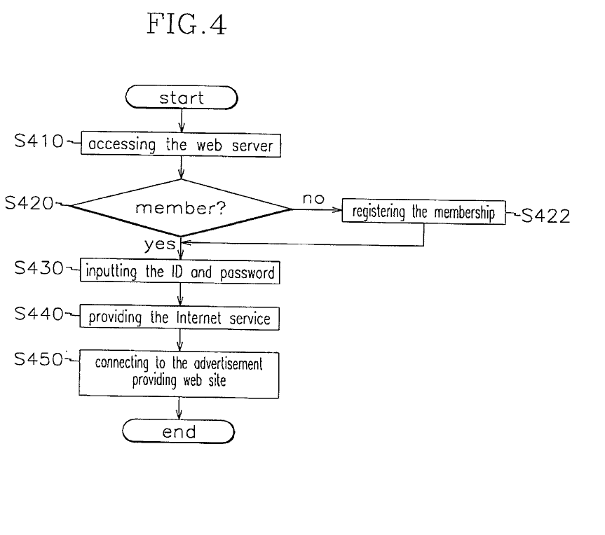

FIG. 4 shows a flow chart for a user to be authenticated according to the preferred embodiment of the present invention.

The Internet user uses his terminal 100 to access the Internet and the web server 120 in step S410.

The terminal 100 enables bidirectional communications. For example, the terminal 100 can be a computer connected to a communication network, mobile communication terminals such as PCS and IMT2000, or digital television enabling bidirectional information communication.

When the Internet user accesses the web server 120, the user authentication server 130 determines a registration state of the Internet user in step S420.

In the case the Internet user is determined to be unregistered, he is requested to register in step S422. Membership information on the age, sex, place of residence and bank account number provided at the time of registration is stored in the user authentication server 130.

In the case the Internet user is found to be a registered member or an unregistered Internet user becomes a registered member, the same is requested to input a member ID and a password in step S430.

When the Internet user inputs the member ID and the password, the user authentication server 130 checks the ID and the password, and when they are identical with those stored in the user authentication server 130, the user authentication server 130 provides corresponding services in step S440.

When the Internet user wishes to watch the advertisements, he is connected to the advertisement providing web site 125 in step S450.

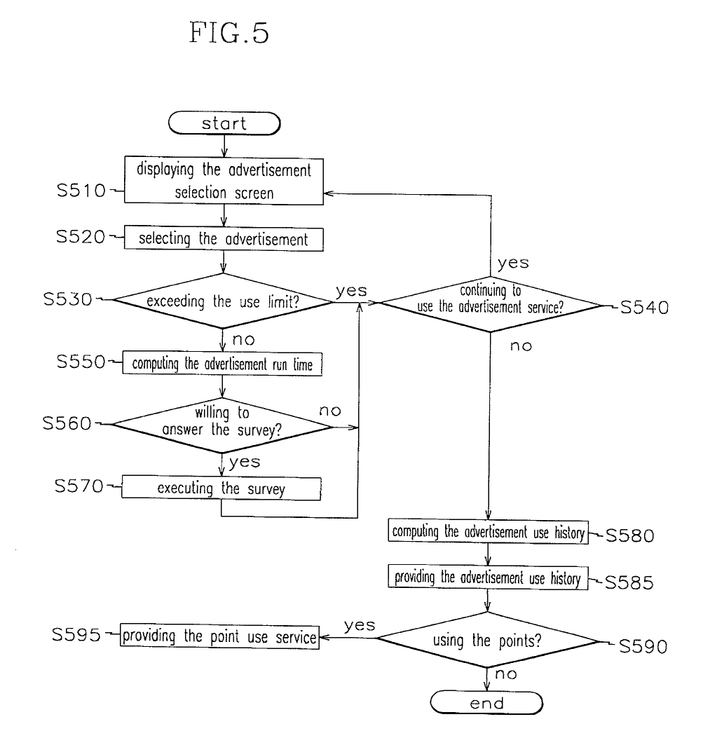

FIG. 5 shows a flow chart of a method for recording an Internet advertisement accessing history according to the preferred embodiment of the present invention.

When the Internet user is connected to the advertisement providing web site 125, the advertisement selection unit 126 selects advertisements to be provided to the Internet user and displays the same on an advertisement selection screen in step S510.

The advertisement selection screen can display advertisement logotypes for representing company names and product names that provide the advertisements, mileage points provided when watching the advertisements, time spent while watching the advertisements, and limits for watching the advertisements.

The limiting methods can be to limit the number of times for a user to watch the advertisements in a given time span (e.g., ten times a day) or to limit the total number regardless of time span (e.g., a total of ten times.)

The advertisements provided to the advertisement selection screen can be advertisements that fit the Internet user's advertisement conditions or all the advertisements regardless of the Internet user's advertisement conditions can be provided.

The Internet user's advertisement conditions comprise the Internet user's age, sex and place of residence.

In the case all the advertisements are provided regardless of the advertisement conditions, it is possible for the Internet user to select the advertisements which do not fit his advertisement conditions and watch the same, but when the Internet user watches the advertisements, the points are not provided to him and are not reflected in the computation of the advertisement cost.

The Internet user watches the advertisement selection screen and selects his desired advertisements in step S520.

The Internet user can select a single advertisement or a plurality of advertisements concurrently on the advertisement selection screen.

After his selection, the web server 120 receives the Internet user's advertisement receipt number from the user authentication server 130 and determines whether the Internet user has exceeded the advertisement use limit in step S530. Through the above-noted procedure, the Internet user is prevented from repeatedly selecting the advertisement on purpose, and accordingly, the sponsor can accurately check the number of Internet users who receive the advertisements.

In the case the Internet user is found to have exceeded the advertisement use limit, the web server 120 displays other advertisements selected by the Internet user, and when no other advertisement is selected, the web server 120 determines whether the Internet user continues to use the advertisement service in step S540.

When it is determined that the Internet user continues to use the advertisement service, the advertisement selection unit 126 selects advertisements to be provided to the Internet user and displays the same on the advertisement selection screen.

When it is determined that the Internet user does not continue to use the advertisement service, the use accumulation unit 129 computes the Internet user's advertisement use history in step S580. A process for computing the advertisement use history will be described later.

When it is determined that the Internet user has not exceeded the advertisement use limit, the advertisement execution unit 127 executes the advertisements selected by the Internet user. At this time, the advertisement execution unit 127 accumulates information on the time per frame provided to the advertisements while executing the advertisements, and computes the actual advertisement run time in step S550. Also, the web server 120 computes the points displayed on the advertisement selection screen and stores the same in the user authentication server 130 when the advertisement is performed.

When the performance of the advertisement is finished, the web server 120 determines whether the Internet user is willing to answer a survey corresponding to the executed advertisement in step S560.

When it is determined that the Internet user is not willing to answer the survey, the web server 120 displays other advertisements selected by the Internet user, and when no other advertisement is selected, the web server 120 determines whether the Internet user continues to use the advertisement service in step S540.

When it is determined that the Internet user continues to use the advertisement service, the advertisement selection unit 126 selects advertisements to be provided to the Internet user and displays the same on the advertisement selection screen.

When it is determined that the Internet user does not continue to use the advertisement service, the use accumulation unit 129 computes the Internet user's advertisement use history in step S580. A process for computing the advertisement use history will be described later.

When it is determined that the Internet user is willing to answer the survey, the survey unit 128 executes a survey on the executed advertisements. Survey items comprise number of Internet uses per day, impressions of the executed advertisements, states of use of the advertised products, and quizzes relating to the advertisements. When the Internet user answers the survey, he can get predetermined points.

Also, depending on the case, the Internet user can get the points only when he wins the quizzes, and thereby the states of whether the Internet user actually watches the advertisements can be checked.

After the survey, the web server 120 displays other advertisements selected by the Internet user, and when no other advertisement is selected, the web server 120 determines whether the Internet user to continues to use the advertisement service in step S540.

When it is determined that the Internet user continues to use the advertisement service, the advertisement selection unit 126 selects advertisements to be provided to the Internet user and displays the same on the advertisement selection screen.

When it is determined that the Internet user does not continue to use the advertisement service, the use accumulation unit 129 computes the Internet user's advertisement use history in step S580.

When computing the Internet user's advertisement use history, the use accumulation unit 129 computes and records the Internet user's personal history and execution history of the respective advertisements.

The recording of Internet users use history comprises the recording of the accumulated number of users according to days, months and years, the recording of the accumulated access time according to days, months and years, and recording of the surveys.

The accumulated number of users, accumulated access time and the surveys are classified according to the Internet users' ages, sex and places of residence. These data are provided to the sponsor in order for the sponsor to analyze the advertisement impact using the same.

The use accumulation unit 129 provides the Internet user's advertisement use history to the Internet user in step S585.

The web server 120 determines whether the Internet user reads the advertisement use history provided by the use accumulation unit 129 and wants to use the points accumulated thus far in step S590.

When the Internet user determines that he does not want to use the accumulated points, the web server 120 terminates the advertisement process.

When the Internet user determines that he wants to use the accumulated points, the web server 120 provides a point use service to the Internet user in step S595.

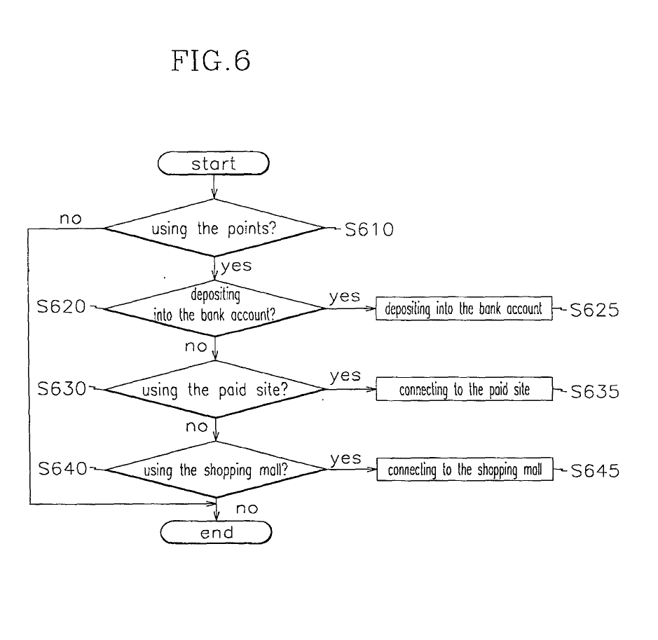

FIG. 6 shows a flow chart of a method for using points according to the preferred embodiment of the present invention.

The Internet user can access the advertisement providing web site 125, watch the selected advertisements and then use the points, or he can access the advertisement providing web site 125 and use the points without watching the advertisements.

The web server 120 determines whether the Internet user wishes to use the points after accessing the advertisement providing web site 125 or after watching all the advertisements selected by the Internet user in step S610.

When it is determined that the Internet user does not wish to use the points, the web server 120 finishes the point use service.

When it is determined that the Internet user wishes to use the points, the web server 120 determines whether the Internet user wishes to receive an amount of money corresponding to the points at a bank account registered by the Internet user at the time of registering as a member in step S620.

When it is determined that the Internet user desires the amount of money to be deposited to his bank account, the web server 120 deposits the money into the bank account of the Internet user in step S625.

When it is determined that the Internet user does not desire the amount of money to be deposited to his bank account, the web server 120 determines whether the Internet user wishes to use paid sites using the accumulated points in step S630.

When it is determined that the Internet user wishes to use the paid sites, the web server 120 connects the Internet user to his desired paid sites in step S635.

When it is determined that the Internet user does not wish to use the paid sites, the web server 120 determines whether the Internet user wishes to use a shopping mail using the accumulated points in step S640.

When it is determined that the Internet user wishes to use the shopping mall, the web server 120 connects the Internet user to his desired shopping mail in step S645.

When it is determined that the Internet user does not wish to use the shopping mall, the web server 120 finishes the point use service.

In the case of providing the point use service, states of whether the money is deposited to the Internet user's bank account, whether the Internet user uses the paid sites and whether the Internet user uses the shopping mall can be asked in many orders, or one of a deposit into the bank account, use of the paid sites or a use of the shopping mall can be selected.

In the above, for ease of description, the method for recording the Internet advertisement access history is described using the Internet, but it is obvious that the method can also be implemented using bidirectional communications, for example, bidirectional communication enabled digital broadcasting.

According to the present invention, the sponsor can accurately know data such as the number of users and advertisement run time.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. In an advertisement access history recording system for obtaining both a number of users who receive the advertisements and advertisement run time, an advertisement access history recording system comprising:
a user authentication server for determining whether a service user who accesses an advertisement providing web site logs in to the advertisement providing web site, and storing the user's personal information;
a web server for managing the advertisement providing web site for storing a selection of the advertisement, execution of the selected advertisement, computation of run time of the selected advertisement and run time of the computed advertisement run time in the user authentication server; and
an advertisement data server for storing the advertisements provided by the advertisement providing web site.

2. The system of claim 1, wherein the advertisement providing web site comprises:
an advertisement selection unit stored in the advertisement data server and having indices linked to the advertisements including execution time per frame and the advertisement data; and
an advertisement execution unit for reproducing the advertisement data when the user executes the selected advertisement and computing the advertisement data reproduction time using the execution time per frame.

3. The system of claim 2, wherein the advertisement providing web site further comprises a survey unit for examining the way of thinking of the service user who executes the advertisement.

4. The system of claim 2, wherein the advertisement providing web site further comprises a use accumulation unit for showing the service user's accumulated incentives provided by the web server.

5. The system of claim 1, wherein the web server provides incentives to the service user who selects and executes the advertisements.

6. The system of claim 1, wherein advertisement conditions for clarifying the users who receive the advertisements are established in the advertisements in the advertisement data server.

7. The system of claim 1, wherein the web server compares the service user's personal information with the advertisement conditions and limits the service users.

8. The system of claim 1, wherein the web server limits the selection of the advertisements when an advertisement use limit stored in the user authentication server is exceeded.

9. The system of claim 1, wherein the web server provides incentives to the service user who answers a survey.

10. In an advertisement access history recording method for obtaining a number of users who receive the advertisements and advertisement run time, an advertisement access history recording method comprising the steps of:
a web server transmitting an advertisement providing web site to a service user;
the web server selecting the advertisements and providing the same to the service user;
the web server receiving the advertisement selected by the service user from the service user;
the web server determining whether the advertisement selected by the service user exceeds a use limit;
the web server executing the advertisement when it is determined that the advertisement selected by the service user does not exceed the use limit; and
the web server providing points to the service user who watches the advertisement.

11. The method of claim 10, wherein the method further comprises a step of the user authentication server determining a log in state of the service user who receives the advertisement providing web site at the user's terminal.

12. The method of claim 10, wherein the advertisement comprises information on time per frame, and when an advertisement execution unit executes an advertisement, the information on the time per frame is accumulated and an advertisement run time is computed.

13. The method of claim 10, wherein the method further comprises a step of the web server comparing advertisement conditions and the service user's conditions and determining whether they are identical when the service user selects an advertisement.

14. The method of claim 10, wherein the advertisement selected by the web server satisfies the service user's advertisement conditions.

15. The method of claim 14, wherein the advertisement conditions comprise the service user's age, sex and place of residence.

16. The method of claim 10, wherein the method further comprises a step of the web server surveying the executed advertisement.

17. The method of claim 10, wherein the method further comprises a step of providing points to the service user when the service user answers a survey.

18. The method of claim 10, wherein the method further comprises a step of providing points to the service user when the service user answers a survey and wins a quiz relating to the advertisement.

19. The method of claim 10, wherein the method further comprises a step of the web server computing an advertisement use history and providing the same to the service user.

20. The method of claim 19, wherein the advertisement use history comprises an accumulated time recording and accumulated points recording.

21. The method of claim 10, wherein the method comprises steps of:
the web server determining whether the service user wishes to use the accumulated points; and
depositing an amount of money corresponding to the accumulated points into the service user's bank account when the service user wishes to use the accumulated points.

22. The method of claim 21, wherein the method further comprises a step of enabling the service user to use the accumulated points on a desired paid site when the service user wishes to use the accumulated points.

23. The method of claim 21, wherein the method further comprises a step of enabling the service user to use the accumulated points at a desired shopping mall when the service user wishes to use the accumulated points.
